(19) United States
(12) Patent Application Publication
(10) Pub. No.: US 2026/0348647 A1
(43) Pub. Date: Nov. 5, 2026

(54) REFRIGERATOR

(71) Applicant: LG Electronics Inc., Seoul (KR)

(72) Inventor: Dahan YE, Seoul (KR)

(21) Appl. No.: 19/651,293

(22) Filed: Apr. 17, 2026

(30) Foreign Application Priority Data
Apr. 30, 2025 (KR) 10-2025-0056940

(51) Int. Cl. F25D 23/02

(52) U.S. Cl. CPC F25D 23/028; F25D 2323/024

(57) ABSTRACT

A refrigerator includes a cabinet, one or more doors, a hinge assembly connected to a door and the cabinet, and a plurality of step adjustment sheets that are stacked or selectively individually moved to adjust a vertical step of the door. By stacking the step adjustment sheets in multiple layers or selectively allowing the step adjustment sheets to move to adjust the vertical step of the door, precise and easy step adjustment in the vertical direction can be achieved even without complete disassembly of the door.

### CROSS-REFERENCE TO RELATED APPLICATION

This application claims priority to and the benefit of Korean Patent Application No. 10-2025-0056940, filed on Apr. 30, 2025, the disclosure of which is incorporated herein by reference in its entirety.

### BACKGROUND

The present disclosure relates to a refrigerator capable of adjusting a step of a door.

A refrigerator is a home appliance for supplying cold air generated using circulation of refrigerant to a storage compartment to keep various types of storage items fresh for a long time. The refrigerator may include a cabinet including one or more storage compartments and a plurality of doors disposed on a front surface of the cabinet to open and close the storage compartments. In this case, a step defect may occur between the doors because the doors may be installed to protrude by different amounts in vertical or horizontal directions. Such a step problem may be caused by various factors, such as minute variations in doors that may occur during a refrigerator manufacturing process, assembly tolerances between the cabinet and the door, etc. When a step occurs between the plurality of doors, it can not only impair the aesthetic appeal of the refrigerator but also lead to defects in the appearance of the refrigerator.

For example, as built-in refrigerators have become common in response to recent consumer demand, it has become essential that the refrigerator doors be installed to precisely match the kitchen cabinets or surrounding interior. To satisfy both aesthetics and functionality, such built-in refrigerators require a process of finely adjusting vertical and horizontal steps of the door during installation.

For example, a method of installing a bracket-type adjustment plate for vertical step adjustment may be used to adjust a step of a refrigerator door. In this method, an adjustment plate separate from a hinge may be installed on the door for door height adjustment. When an additional bracket-shaped adjustment plate separate from the hinge is used for vertical step adjustment, the bracket shape becomes more complex, and thus a sufficient space may be required to install the adjustment plate. Accordingly, there is a problem of increased number of components and installation processes. This can lead to increased refrigerator installation time and cause an increase in manufacturing costs.

As another example, a method of performing horizontal step adjustment and vertical step adjustment of a door at different fastening portions of a hinge may be used. For example, horizontal step adjustment of the door may be performed at a connection portion between the hinge and the door, and vertical step adjustment of the door may be performed at a connection portion between the hinge and a cabinet. That is, when horizontal and vertical step adjustments are not performed comprehensively at a single point but are adjusted independently at different portions, there is a problem in that the adjustments become cumbersome and less intuitive for a user.

In addition, for vertical and horizontal step adjustments of the hinge, when a door step is adjusted by moving the hinge in the vertical or horizontal direction, problems may arise with a fastening force of the hinge, or there may be difficulties in matching steps between adjacent doors.

In addition, since the door and portions of the product may require disassembly and reassembly during step adjustment, the inconvenience and hassle of having to remove and reinstall the product in narrow spaces, such as an installation environment of a built-in refrigerator, may increase. However, such difficulty in adjusting a door step is not limited to built-in refrigerators but may also apply to refrigerators of a general installation type in the same manner.

Accordingly, there is a need to develop a refrigerator that satisfies both the spatial constraints of the refrigerator installation environment and user convenience and also has a step adjustment method enabling accurate step adjustment and easy maintenance during installation.

### SUMMARY

The present disclosure is directed to providing a refrigerator capable of precise and easy step adjustment of a door even without complete disassembly of the door.

The present disclosure is also directed to providing a refrigerator capable of convenient and smooth step adjustment of a door even in a narrow installation environment.

The present disclosure is also directed to providing a refrigerator capable of accurately guiding a movement trajectory of a step adjustment sheet for adjusting a door step.

The present disclosure is also directed to providing a refrigerator capable of preventing the loss of a step adjustment sheet for adjusting a door step.

The present disclosure is also directed to providing a refrigerator capable of increasing space utilization and improving work convenience in narrow spaces by storing a step adjustment sheet for adjusting a door step.

The present disclosure is also directed to providing a refrigerator capable of more precise vertical step adjustment of a door.

The present disclosure is also directed to providing a refrigerator capable of increasing the ease of replacement and reducing maintenance costs of a step adjustment sheet for adjusting a door step.

The present disclosure is also directed to providing a refrigerator capable of precisely adjusting not only a vertical step of a door but also a horizontal step of the door through a hinge assembly.

The present disclosure is also directed to providing a refrigerator capable of comprehensively adjusting vertical and horizontal steps of a door.

The present disclosure is also directed to providing a refrigerator capable of preventing the occurrence of problems of reduced fastening force between a hinge assembly and a cabinet.

Objects of the present disclosure are not limited to the above objects, and other objects and advantages of the present disclosure that are not described can be understood by the following description and will be more clearly understood by various embodiments of the present disclosure. In addition, it will be able to be easily seen that the objects and advantages of the present disclosure may be achieved by devices and combinations thereof that are described in the claims.

According to one embodiment of the present disclosure, there is provided a refrigerator including a cabinet including one or more storage compartments, one or more doors configured to open and close the storage compartments, a hinge assembly connected to the door and the cabinet so that the door is rotatable from the cabinet, and a plurality of step adjustment sheets which are stacked or selectively moved to adjust a vertical step of the door.

The step adjustment sheet may be disposed between the hinge assembly and an upper surface of the door or a lower surface of the door.

The step adjustment sheet may move in a horizontal direction.

The step adjustment sheet may be inserted and withdrawn in a sliding manner.

The refrigerator may include one or more moving guide members configured to connect the step adjustment sheet and the hinge assembly and guide movement of the step adjustment sheet, wherein the step adjustment sheet may include a slot guide portion which is open in a direction of movement of the step adjustment sheet to allow the moving guide member to pass through the step adjustment sheet.

The slot guide portion may extend in one direction in a closed loop form.

An upper surface of the door or a lower surface of the door may include a recess which is recessed to store the moved step adjustment sheet.

The step adjustment sheet may be separated from the hinge assembly.

The step adjustment sheet may be rotated about a single axis.

The hinge assembly may include a hinge member including a plurality of joints, and a hinge mounting plate configured to fasten the hinge member to an upper or lower surface of the door, the hinge mounting plate may include one or more fastening holes fastened to the door, and the fastening holes may extend and may be open in a horizontal movement direction of the door.

The step adjustment sheet may be fastened to an upper or lower surface of the hinge mounting plate.

The hinge assembly may include a step adjustment member which is fastened and unfastened in a horizontal directions of the door to adjust a horizontal step of the door.

The refrigerator may further include a door mounting bracket whose one side and the other side are fastened to the hinge assembly and the door, respectively, wherein the door mounting bracket may include a through-hole through which the step adjustment member passes, and the through-hole may include an extension opening hole extending in one direction along a vertical movement direction of the door.

According to another aspect of the present disclosure, there is provided a refrigerator including a cabinet including one or more storage compartments, one or more doors configured to open and close the storage compartments, and a hinge assembly including a hinge member connected to the door and the cabinet so that the door is rotatable from the cabinet, wherein the hinge assembly includes, in a state in which the hinge member is fixed, a plurality of step adjustment sheets configured to adjust a vertical step of the door and one or more step adjustment members configured to adjust a horizontal step of the door.

The hinge assembly may include a hinge mounting plate configured to guide horizontal movement of the plurality of step adjustment sheets and guide horizontal movement of the door.

The door may include a recess which is recessed to store the moved step adjustment sheets, the door may be maximally moved upward in a state in which the plurality of step adjustment sheets are stacked between the hinge mounting plate and an upper or lower surface of the door, and the door may be maximally moved downward in a state in which the plurality of step adjustment sheets are seated in the recess.

The plurality of step adjustment sheets may be inserted and withdrawn in a front-rear direction, when the step adjustment sheet is withdrawn, the step adjustment sheet which is closer to an upper or lower surface of the door than the hinge mounting plate may be withdrawn preferentially, and when the step adjustment sheet is inserted, the step adjustment sheet which is closer to the hinge mounting plate than the upper or lower surface of the door may be inserted preferentially.

The refrigerator may further include a moving guide member which passes through a slot guide portion of the plurality of step adjustment sheets and is fastened to the hinge member, wherein the slot guide portion may be formed to extend in a front-rear direction, and the plurality of step adjustment sheets may be inserted and withdrawn in a sliding manner in the front-rear direction along the slot guide portion.

The hinge mounting plate may include one or more fastening holes formed to be fastened to an upper or lower surface of the door by a fastening member, and the fastening holes may extend and may be open in a horizontal movement direction of the door.

A location of the fastening member located in the fastening hole may vary depending on a direction in which the step adjustment member is rotated.

In the refrigerator according to one embodiment of the present disclosure, by stacking the step adjustment sheets in multiple layers or selectively allowing the step adjustment sheets to move to adjust the vertical step of the door, precise and easy step adjustment in the vertical direction can be achieved even without complete disassembly of the door.

In addition, in the refrigerator according to one embodiment of the present disclosure, by horizontally moving or inserting or withdrawing the step adjustment sheet for adjusting the vertical step of the door in a sliding manner, convenient and smooth vertical step adjustment can be achieved even in narrow installation environments.

In addition, in the refrigerator according to one embodiment of the present disclosure, by guiding movement of the step adjustment sheet so that the step adjustment sheet moves only along the designated path, the movement trajectory of the step adjustment sheet can be accurately guided.

Accordingly, the step adjustment sheet can be prevented from being unnecessarily removed or damaged during the step adjustment process, and stable and repeated step adjustment can be achieved even in a narrow installation environment.

In addition, in the refrigerator according to one embodiment of the present disclosure, since the slot guide portion of the step adjustment sheet that moves along the moving guide member is formed to have a closed loop shape, the step adjustment sheet is not completely separated from the hinge assembly even when the step adjustment sheet moves, thereby preventing the loss of the step adjustment sheet.

In addition, in the refrigerator according to one embodiment of the present disclosure, since the moved step adjustment sheet can be stored in the recess formed in the door, the step adjustment sheet is neatly stored in the door without protruding outward, thereby not only increasing space utilization and improving work convenience in narrow spaces, but also effectively preventing the loss of the step adjustment sheet.

In addition, in the refrigerator according to one embodiment of the present disclosure, by separating the step adjustment sheet from the hinge assembly, the number of stacked step adjustment sheets can be freely adjusted, thereby enabling more precise vertical step adjustment of the door.

In addition, when the step adjustment sheet is damaged, only the damaged step adjustment sheet can be easily replaced, thereby enabling ease of replacement and a reduction in maintenance costs.

In addition, since the refrigerator according to one embodiment of the present disclosure includes the step adjustment member that is fastened and unfastened in the horizontal direction of the door so that the hinge assembly adjusts the horizontal step of the door, the hinge assembly can precisely adjust not only the vertical step of the door but also the horizontal step of the door.

In addition, in the refrigerator according to one embodiment of the present disclosure, since the through-hole of the door mounting bracket through which the step adjustment member for adjusting the door step in the horizontal direction passes includes the extension opening hole extending in the vertical movement direction of the door, the vertical and horizontal step adjustments of the door can be substantially controlled integrally at the same location, thereby further improving workability and intuitiveness for step adjustment.

In addition, in the refrigerator according to one embodiment of the present disclosure, the vertical and horizontal steps of the door may be adjusted through a plurality of step adjustment sheets and step adjustment members in a state in which the hinge member is fixed, thereby preventing a reduction in fastening force between the hinge assembly and the cabinet due to frequent unfastening of the hinge assembly and allowing the step between adjacent doors to be matched more accurately.

Specific effects of the present disclosure together with the above effects will be described with a description of the following detailed matters for carrying out the invention.

### BRIEF DESCRIPTION OF THE DRAWINGS

FIG. 1 is a front perspective view of a refrigerator when a door is in an open state.

FIGS. 2 and 3 are enlarged views illustrating an upper region of a first door connected to a cabinet by a first hinge assembly when the first door is in closed and open states, respectively.

FIG. 4 is an enlarged view illustrating a lower region of the first door connected to the cabinet by a first hinge member of a second hinge assembly when the second door is in a removed state and the first door is in an open state.

FIG. 5 is an enlarged view illustrating an upper region of a second door connected to the cabinet by a second hinge member of the second hinge assembly when the first door is in a removed state and the second door is in an open state.

FIG. 6 is an enlarged view illustrating a lower region of the second door connected to the cabinet by a third hinge assembly when the second door is in an open state.

FIG. 7 illustrates the second hinge assembly fastened to the lower region of the first door and the upper region of the second door.

FIG. 8 is an exploded perspective view of the second hinge assembly and door mounting brackets.

FIG. 9 is an exploded perspective view of a hinge mounting plate and a step adjustment sheet of the second hinge assembly.

FIG. 10 illustrates the second hinge assembly separated from a door outer bracket mounted on the upper region of the second door.

FIG. 11 illustrates a case in which a step adjustment sheet is fully inserted in a state in which the second hinge assembly is mounted on the upper region of the second door.

FIGS. 12 and 13 illustrate, from different viewpoints, a case in which the step adjustment sheet is fully withdrawn and stored in a recess in a state in which the second hinge assembly is mounted on the upper region of the second door.

FIG. 14 is a cross-sectional view of the portion indicated in FIG. 13.

FIG. 15 is a cross-sectional view of the portion indicated in FIG. 2, which illustrates a case in which the step adjustment sheet is fully inserted in a state in which the first hinge assembly is mounted on the upper region of the first door.

FIG. 16 is a cross-sectional view of the portion indicated in FIG. 2, which illustrates a state before a second direction fastening member is fully tightened after a first step adjustment sheet is withdrawn in a state in which the first hinge assembly is mounted on the upper region of the first door.

FIG. 17 is a cross-sectional view of the portion indicated in FIG. 2, which illustrates a state after the first step adjustment sheet is withdrawn and the second direction fastening member is fully tightened in a state in which the first hinge assembly is mounted on the upper region of the first door.

FIGS. 18 and 19 are cross-sectional views of the respective different portions indicated in FIG. 2, which illustrates a state after the step adjustment sheet is fully withdrawn and the second direction fastening member is fully tightened in a state in which the first hinge assembly is mounted on the upper region of the first door.

FIG. 20 is a cross-sectional view illustrating a state after the first step adjustment sheet and the second step adjustment sheet are withdrawn and the second direction fastening member is fully tightened in a state in which the first hinge member of the second hinge assembly is mounted on the lower region of the first door.

FIG. 21 is a front view illustrating an enlarged portion of the first hinge assembly according to FIG. 3.

FIG. 22 illustrates a state in which a step adjustment sheet according to another embodiment is disposed in the upper region of the second door.

FIGS. 23-26 are views in a case in which a step adjustment sheet according to still another embodiment is mounted on the hinge assembly.

FIG. 27 is a schematic view for describing step adjustment directions of the first door and the second door according to one embodiment.

### DETAILED DESCRIPTION

The above objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted. Hereinafter, exemplary embodiments according to the present disclosure will be described in detail with reference to the accompanying drawings. In the drawings, the same reference numerals are used to denote the same or similar components.

Although the terms “first,” “second,” etc., are used to describe various components, it is apparent that these components are not limited by these terms. These terms are used only to distinguish one component from another, and unless otherwise stated, it is obvious that a first component may be a second component. Throughout the specification, unless otherwise stated, each component may be singular or plural.

Hereinafter, the arrangement of an arbitrary component on an “upper portion (or lower portion)” of a component or “above (or under)” the component may not only mean that the arbitrary component is disposed in contact with an upper surface (or a lower surface) of the component, but also mean that other components may be interposed between the component and the arbitrary component disposed above (or under) the component. In addition, when a certain component is described as being “connected,” “coupled,” or “joined” to the other component, the components may be directly connected or joined, but it should be understood that another component may be “interposed” between the components, or the components may be “connected,” “coupled,” or “joined” through another component.

The singular expression used herein includes the plural expression unless the context clearly dictates otherwise. In the application, terms such as “composed of” or “comprising” should not be construed as necessarily including all of the various components or operations described in the specification and should be construed as not including some of the components or some of the operations or further including additional components or operations.

Hereinafter, a refrigerator according to some embodiments of the present disclosure will be described.

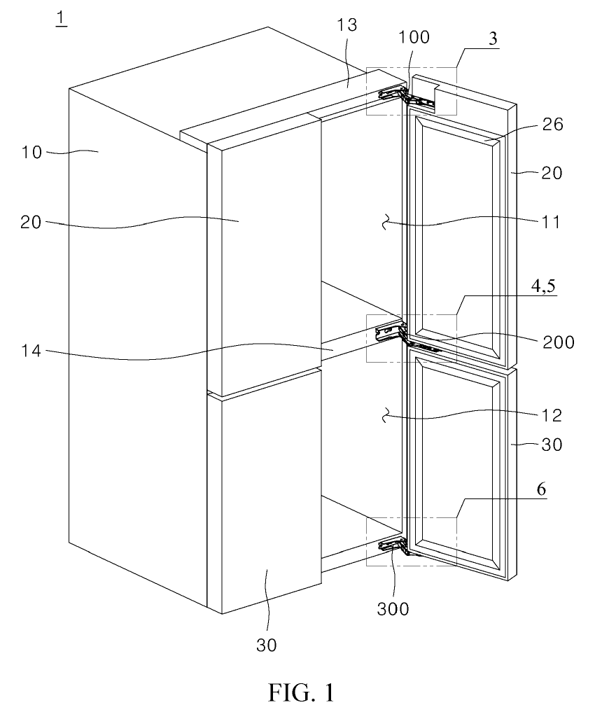

First, a hinge assembly connecting a cabinet and door of a refrigerator according to one embodiment of the present disclosure and a connection relationship of major components constituting the hinge assembly will be described with reference to FIGS. 1-6.

A refrigerator 1 may have the appearance formed by a cabinet 10 including one or more storage compartments, which are product storage spaces, and one or more doors capable of opening and closing an open front surface of the cabinet 10. The cabinet 10 may include an outer case forming an outer surface of the refrigerator 1 and an inner case forming an inner surface thereof with an insulation space interposed therebetween. An interior of the inner case may be divided into one or more storage spaces. For example, the cabinet 10 may include a first storage compartment 11 and a second storage compartment 12 disposed in the vertical direction with a barrier portion interposed therebetween. For example, an insulating foam material, which is an insulation member, may be injected into the insulation space, and the insulation space may be filled with the insulating foam material.

For example, the first storage compartment 11 and the second storage compartment 12 may be opened and closed by a pair of first doors 20 and a pair of second doors 30, which are disposed side by side in the horizontal direction, respectively. The first door 20 may be rotatably connected to the cabinet 10 by a first hinge assembly 100 and a second hinge assembly 200 that are coupled to upper and lower ends thereof, respectively. In addition, a second door 30 may be rotatably connected to the cabinet 10 by the second hinge assembly 200 and a third hinge assembly 300 that are coupled to upper and lower ends thereof, respectively. The first hinge assembly 100 and the third hinge assembly 300 may be single-fastening hinge assemblies that are fastened to one door through a single hinge member. In addition, the second hinge assembly 200 may be a double-fastening hinge assembly connected to two doors through two hinge members. A hinge cover 13 may be disposed on an upper surface of the cabinet 10. For example, the hinge cover 13 may be disposed at a front end of the upper surface of the cabinet 10 to cover an upper surface of the first hinge assembly 100.

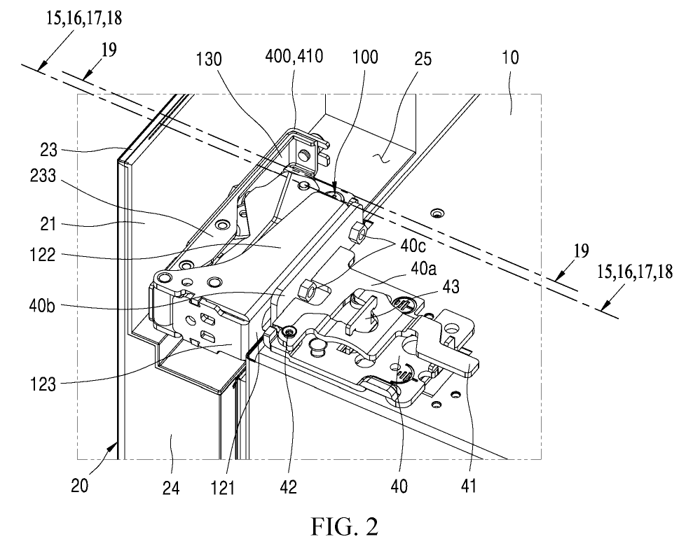

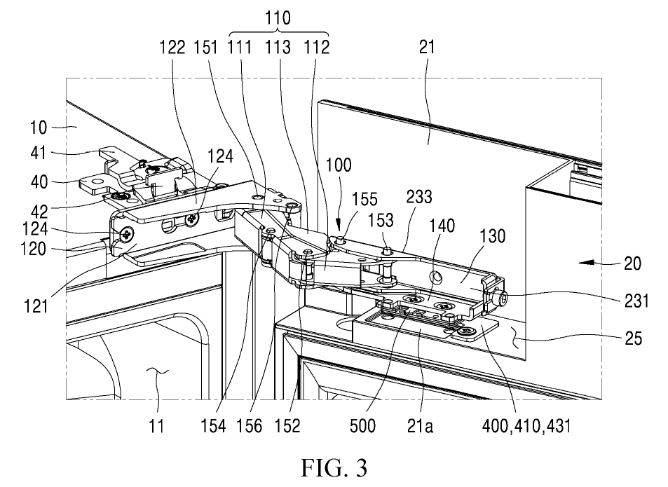

FIGS. 2 and 3 illustrate the first hinge assembly 100 connecting the cabinet 10 and the first door 20 when the first door 20 is in a closed state and an open state, respectively.

Upper and lower surfaces of the first door 20 may be finished by a first upper cap deco 21 and a first lower cap deco 22, respectively; front and rear surfaces thereof may be finished by a front plate 23 and a door liner 26, respectively; and both side surfaces thereof may be finished by a pair of side frames 24. The second door 30 to be described below may also be configured to have the same structure. In the present specification, the front surface refers to the surface facing forward toward a user when the door is in a closed state, and the rear surface refers to the surface facing rearward. Accordingly, the direction connecting the front and rear surfaces of the door may be the front-rear direction, and the direction connecting the two side surfaces of the door may be the horizontal direction.

A cabinet fixing bracket 40 may be disposed at the front end of the upper surface of the cabinet 10. The cabinet fixing bracket 40 may include a support 40a fastened to the upper surface of the cabinet 10, and a fixing portion 40b bent upward from a front end of the support 40a so as to face forward. A restraining member 41 connected to be rotatable about a rotational pin 42 provided on one side of the support 40a may be disposed on the support 40a. A restraining rib 43 fastened by passing through the restraining member 41 in the vertical direction to prevent the restraining member 41 from being removed may be disposed on the restraining member 41.

The first hinge assembly 100 may be located in a first hinge mounting portion 25 formed in the first upper cap deco 21. The first hinge mounting portion 25 may be formed such that a rear surface and one side surface are open and a front and the other side surface are closed. A door mounting bracket 400 may be disposed on the first hinge mounting portion 25. The door mounting bracket 400 may fasten the first hinge assembly 100 to the first door 20. The door mounting bracket 400 may be disposed on an upper surface of the first upper cap deco 21 so as to be exposed to the outside. Accordingly, the door mounting bracket 400 may be referred as to a door outer bracket 410. In addition, the door outer bracket 410 disposed on an upper outer surface of the first door 20 may be referred to as an upper door upper outer bracket 431. The upper door upper outer bracket 431, which is the door outer bracket 410, may be fastened to an upper door upper inner bracket 441, which is the door inner bracket 420 disposed on an upper inner surface of the first door 20, with the first upper cap deco 21 interposed therebetween, which will be described below.

The first hinge assembly 100 may include a first cabinet mounting bracket 120. The first cabinet mounting bracket 120 may be fastened to a fastening portion 40c formed on a fixing portion 40b of the cabinet fixing bracket 40 through a fastening member 124. Accordingly, one side of the first hinge assembly 100 may be fixed to the front surface of the cabinet 10. The first cabinet mounting bracket 120 may include a base portion 121 fastened to the fixing portion 40b, a pair of extensions 122 formed to extend forward from upper and lower ends of the base portion 121, and a side portion 123 extending forward from a side end of the base portion 121 to connect the pair of extensions 122.

The first hinge assembly 100 may include a first hinge mounting bracket 130. The first hinge mounting bracket 130 may include a bracket body portion 231 fastened to one surface of the door mounting bracket 400 bent forward, and a pair of bracket coupling portions 233 formed to extend rearward from upper and lower ends of the bracket body portion 231. The first hinge mounting bracket 130 may be fastened to the door mounting bracket 400 through a fastening member passing through the bracket body portion 231. Accordingly, the other side of the first hinge assembly 100 may be fixed to the first hinge mounting portion 25 of the first door 20.

At least a portion of a hinge member 110 having a multi-joint hinge structure in which a plurality of joints are joined may be stored within the first cabinet mounting bracket 120 and the first hinge mounting bracket 130. A rotational trajectory of the hinge member 110 may be determined by a plurality of joint joining structures constituting the hinge member 110. Accordingly, the first door 20 may be opened at an opening angle and trajectory that does not interfere with furniture, walls, etc. disposed on the side thereof.

For example, the hinge member 110 may include a plurality of joints including a first link 111, a second link 112, and a third link 113. The joints that are axially coupled may generally be formed in a quadrilateral shape and may provide a rotational trajectory along which the first door 20 may be rotated by folding or unfolding.

One side of the first link 111 may be axially coupled to the first cabinet mounting bracket 120 via a first rotational shaft 151 disposed between the pair of extensions 122, and the other side may be axially coupled to the second link 112 via a second rotational shaft 152.

One side of the second link 112 may be axially coupled to the first link 111 via the second rotational shaft 152, and the other side may be axially coupled to the first hinge mounting bracket 130 via a third rotational shaft 153 disposed between the pair of bracket coupling portions 233. For example, a spring for forcing rotation of the second link 112 by being tensioned or compressed as the second link 112 rotates. The spring may be compressed during the process of closing the first door 20 and restored just before the second door 30 is closed.

One side of the third link 113 may be axially coupled to the first link 111 via a fourth rotational shaft 154, and the other side may be axially coupled to the first hinge mounting bracket 130 via a fifth rotational shaft 155 disposed between the pair of bracket coupling portions 233. For example, the first cabinet mounting bracket 120 and the third link 113 may be connected by a linear damper. One side of the linear damper may be axially coupled to the first cabinet mounting bracket 120 via a sixth rotational shaft 156 disposed between the pair of extensions 122, and the other side may be coupled to the third link 113. The linear damper can reduce a rotational speed and mitigate an impact when the first door 20 is closed. Through operations of the linear damper and the spring, the plurality of links constituting the hinge member 110 may rotate smoothly while maintaining a set trajectory.

The first hinge assembly 100 may include a first hinge mounting plate 140. The first hinge mounting plate 140 may be disposed horizontally so as to be orthogonal to the bracket body portion 231 of the first hinge mounting bracket 130. The first hinge mounting plate 140 may be fastened to the first hinge mounting bracket 130 and the hinge member 110 by the third rotational shaft 153 and the fifth rotational shaft 155 passing through the first hinge mounting plate 140. For example, the third rotational shaft 153 and the fifth rotational shaft 155 may be formed of rivets.

One or more step adjustment sheets 500 capable of adjusting a vertical step of the first door 20 may be disposed on a lower surface of the first hinge assembly 100. The step adjustment sheet 500 may be disposed between the first hinge mounting plate 140 and the door mounting bracket 400. For example, the step adjustment sheet 500 may be fixed to a lower surface of the first hinge mounting plate 140. In addition, a first upper recess 21a that is recessed downward may be formed on the first hinge mounting portion 25 such that the step adjustment sheet 500 may be stored and seated thereon.

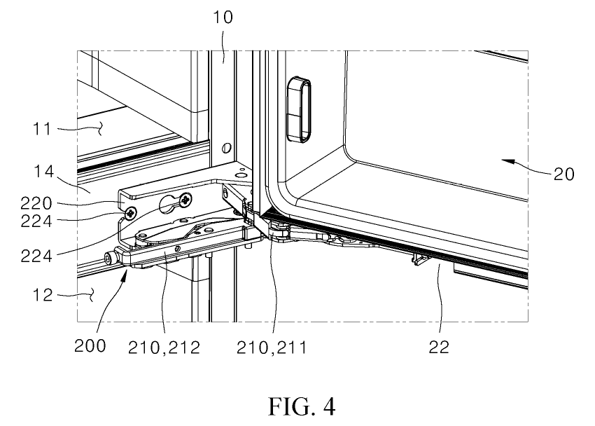

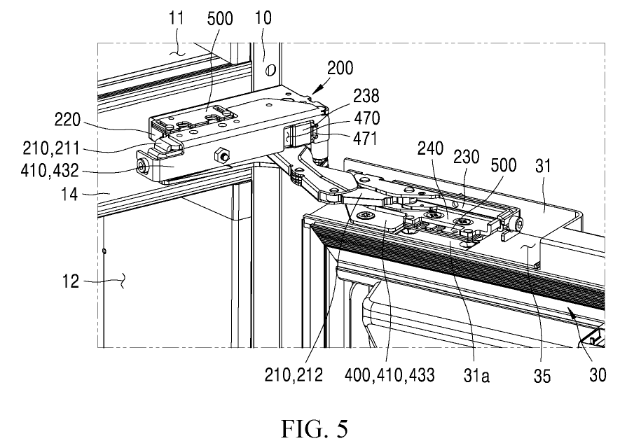

Referring to FIGS. 4 and 5, the second hinge assembly 200 may be disposed between the first door 20 and the second door 30. The second hinge assembly 200 may include a second cabinet mounting bracket 220, and a first hinge member 211 and a second hinge member 212 that may be folded to be stored in the second cabinet mounting bracket 220. That is, the first hinge member 211 and the second hinge member 212 may share a single second cabinet mounting bracket 220. The first hinge member 211 may be disposed above the second hinge member 212. The first hinge member 211 fastened to the lower portion of the first door 20 may be subjected to a stronger load of the door applied in the downward direction than the second hinge member 212 fastened to the upper portion of the second door 30. Accordingly, to allow the strength of the first hinge member 211 to be greater than that of the second hinge member 212, the thickness of the first hinge member 211 is preferably greater than that of the second hinge member 212. The second cabinet mounting bracket 220 may be fastened to a front surface of the barrier portion by one or more fastening members 224.

The first hinge member 211 and the second hinge member 212 may be folded or unfolded independently of each other. That is, the first hinge member 211 and the second hinge member 212 may share the second cabinet mounting bracket 220 fastened to the front surface of the barrier portion 14, thereby increasing space utilization and allowing the opening and closing of the first door 20 and the second door 30 to be performed independently of each other.

One side of the first hinge member 211 may be located at the hinge mounting portion formed on a lower surface of a first lower cap deco 22 of the first door 20. On the lower surface of the first lower cap deco 22, an upper door lower outer bracket 432, which is the door mounting bracket 400, may be disposed such that one side of the first hinge member 211 may be fastened to the lower surface of the first door 20.

One side of the second hinge member 212 may be located on the second hinge mounting portion 35 of a second upper cap deco 31 of the second door 30. On an upper surface of the second upper cap deco 31, a lower door upper outer bracket 433, which is the door mounting bracket 400, may be disposed such that one side of the second hinge member 212 may be fastened to the upper surface of the second door 30. The first hinge member 211 and the second hinge member 212 of the second hinge assembly 200 may each include the first hinge mounting bracket 230, the first hinge mounting plate 240, and the step adjustment sheet 500 that are separately provided.

Referring to FIG. 5, the upper door lower outer bracket 432, which is the door outer bracket 410 fastened to the upper surface of the first hinge member 211, may be fastened to an upper door lower inner bracket 442, which is the door inner bracket 420. The upper door lower outer bracket 432 and the upper door lower inner bracket 442 are fastened to each other with the first lower cap deco 22 interposed therebetween, and the first lower cap deco 22 is omitted in FIG. 5 for convenience of description. In addition, an insertion hole 470 consisting of a predetermined opening region may be formed in a front surface of the upper door lower outer bracket 432, and a hook portion 471 may be formed in the insertion hole 470. The hook portion 471 may be fastened to a hook insertion portion 238 formed on the front surface of the first hinge member 211 in the horizontal direction, thereby improving a fastening force between the first hinge member 211 and the upper door lower outer bracket 432. The fastening using the hook portion and the hook insertion portion can also be implemented in the same manner between another hinge member and the door mounting brackets.

The second cabinet mounting bracket 220, the second hinge mounting bracket 230, and the second hinge mounting plate 240 of the second hinge assembly 200 may be understood with reference to the description of the first cabinet mounting bracket 120, the first hinge mounting bracket 130, and the first hinge mounting plate 140 of the first hinge assembly 100. In addition, the first hinge member 211 and the second hinge member 212 of the second hinge assembly 200 may be understood with reference to the description of the hinge member 110 of the first hinge assembly 100. In addition, the door outer bracket 410 fastened to each of the lower portion of the first door 20 and the upper portion of the second door 30 may be understood with reference to the description of the door outer bracket 410 fastened to the upper portion of the first door 20.

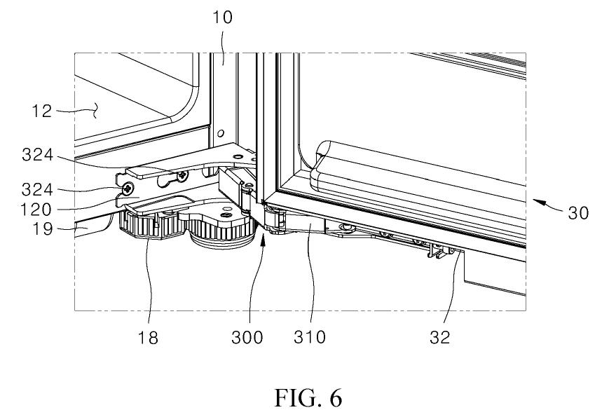

Referring to FIG. 6, the third hinge assembly 300 may be located on a hinge mounting portion formed on a second lower cap deco 32. One side of the hinge member 310 included in the third hinge assembly 300 may be fixed to the front surface of the cabinet 10 by the cabinet mounting bracket 120, and the other side may be fastened to the lower surface of the second lower cap deco 32. The cabinet mounting bracket 120 may be fastened to the front surface of the cabinet 10 by one or more fastening members 324. A height adjustment portion 18 for adjusting the height of the cabinet 10 and a roller portion 19 for assisting in moving the cabinet 10 may be disposed on the lower surface of the cabinet 10. The third hinge assembly 300 is preferably disposed above the height adjustment portion 18 or the roller portion 19 so that an unfolding or folding motion is not interfered with.

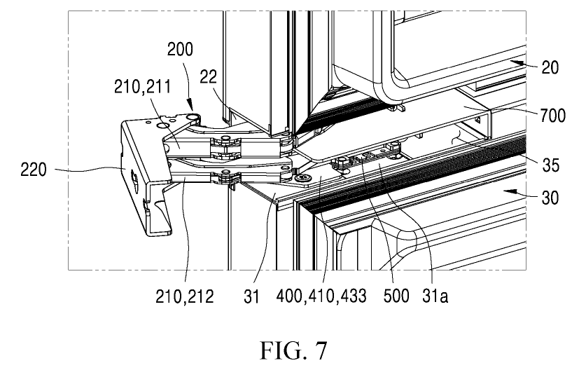

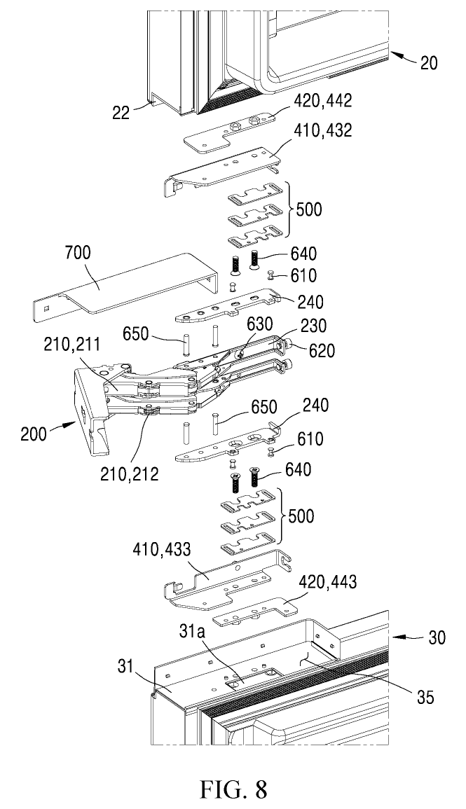

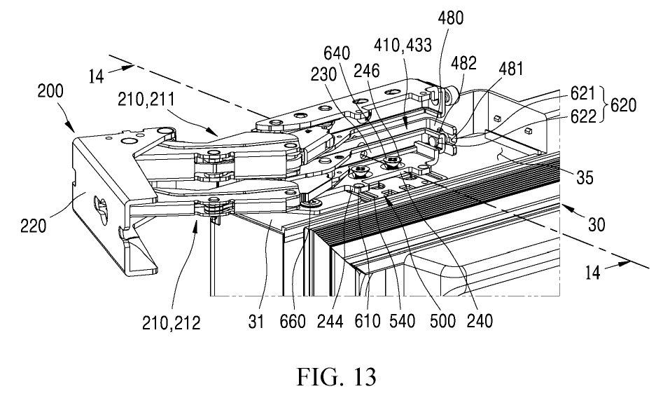

Hereinafter, the fastening structure between the hinge assembly and the door will be described in more detail with further reference to FIGS. 7-14 using the fastening structure between the second hinge assembly 200 and the first door 20 as an example.

The second hinge assembly 200 may include a plurality of hinge members 210 disposed in the vertical direction. For example, a plurality of hinge members 210 may include the first hinge member 211 fastened to the first lower cap deco 22 of the first door 20 and the second hinge member 212 fastened to the second upper cap deco 31 of the second door 30. For example, the first hinge member 211 and the second hinge member 212 may be fastened to each door in substantially the same manner.

For example, the second hinge mounting bracket 230 may be connected to one side of the first hinge member 211, and the second hinge mounting plate 240, the plurality of step adjustment sheets 500, and the upper door lower outer bracket 432 may be disposed between the first hinge member 211 and the first lower cap deco 22. In this case, the upper door lower outer bracket 432 may be fastened to the upper door lower inner bracket 442 disposed on an upper surface of the first lower cap deco 22.

The second hinge mounting bracket 230 of the first hinge member 211 may be fastened to the upper door lower outer bracket 432 by a first direction fastening member 630 fastened and unfastened in the first direction, which is the front-rear direction. In addition, the second hinge mounting bracket 230 and the second hinge mounting plate 240 of the first hinge member 211 may be fastened by a second direction fixing member 650 passing therethrough in the second direction, which is the vertical direction. In this case, the second direction fixing member 650 may constitute the third rotational shaft 153 and the fifth rotational shaft 155 of the hinge member 110. In addition, the plurality of step adjustment sheets 500 may be fixed to an upper surface of the second hinge mounting plate 240 by a plurality of moving guide members 610 fastened in the vertical direction.

A hinge cap 700 may be disposed between the first hinge member 211 and the second hinge member 212. The hinge cap 700 may be formed to cover an upper surface of the second hinge member 212. The hinge cap 700 may be formed to also cover front and side surfaces of the second hinge member 212 and fastened to rear and side surfaces of the second upper cap deco 31 constituting the second hinge mounting portion 35. In this way, as the hinge cap 700 is disposed to cover the upper surface of the second hinge member 212, the upper surface of the first hinge member 211 can be prevented from being exposed to the outside when only the first door 20 is opened when the second door 30 is in a closed state, or when only the second door 30 is opened in a state in which the first door 20 is in a closed state. Accordingly, damage to the first hinge member 211 can be prevented, and the user’s aesthetic sense can be enhanced.

The second hinge member 212 may also have fastening and component configuration implemented in substantially the same manner as the first hinge member 211. Hereafter, the fastening structure between the second hinge member 212 and the second door 30 will be described in detail, and the same description may also be applied to the fastening structure between the first hinge member 211 and the first door 20.

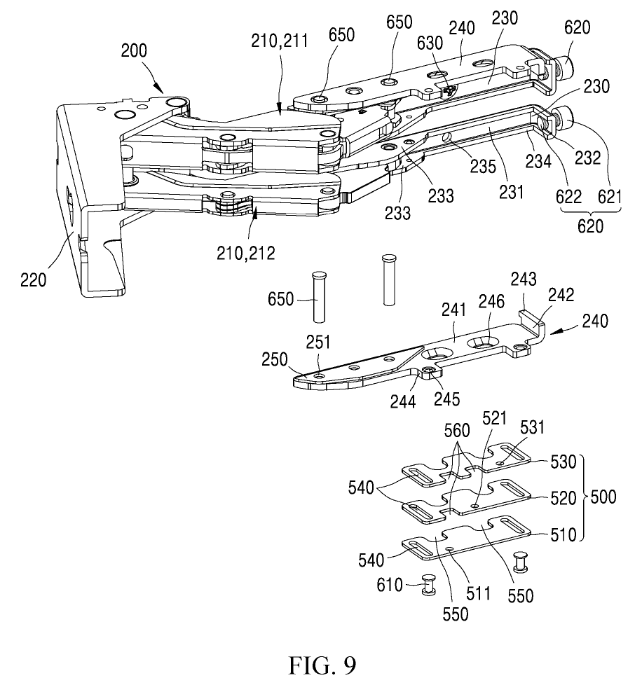

Referring to FIG. 9, the second hinge mounting bracket 230 fastened to one side of the second hinge member 212 may include the bracket body portion 231 extending in the horizontal direction. The bracket body portion 231 may be disposed so that a surface having a large area faces forward. One or more screw holes 235 passing through the bracket body portion 231 in the front-rear direction may be formed in the bracket body portion 231. At upper and lower ends of one side of the bracket body portion 231, the bracket coupling portion 233 that is bent horizontally and extends rearward may be formed, thereby providing a rotational shaft fastened to the second hinge member 212.

On the other side of the bracket body portion 231, a bracket bent portion 232 that is bent vertically from a side end and extends rearward may be formed. A step adjustment member 620 passing through the bracket bent portion 232 in the horizontal direction may be fastened to the bracket bent portion 232. For example, the step adjustment member 620 may be a bolt member or a screw member that can be easily fastened and unfastened by a screw fastening method. The step adjustment member 620 may be fastened and unfastened outward from the bracket bent portion 232, thereby increasing the user’s workability. The step adjustment member 620 may include a head portion 621 and a shaft portion 622 that extends cylindrically from one side of the head portion 621 and has screw threads formed on an outer circumferential surface thereof. For example, a user may rotate the head portion 621 using a tool such as a wrench or screwdriver to fasten and unfasten the step adjustment member 620.

A catch 234 may be formed along a rear edge portion formed at the upper and lower ends of the bracket body portion 231. For example, the catch 234 may protrude rearward along the same line as the bracket coupling portion 233 and protrude by a length shorter than that by which the bracket coupling portion 233 extends rearward. The catch 234 may be formed to be continuously connected from the rear edge portion of the bracket body portion 231 to a rear edge portion of the bracket bent portion 232. The catch 234 may reinforce the strength of the second hinge mounting bracket 230. In addition, the catch 234 may be used to increase the fastening force with the second hinge mounting plate 240 in an upward or downward direction.

The second hinge mounting plate 240 may include a plate body portion 241 extending in the horizontal direction. The plate body portion 241 may be disposed to be orthogonal to the bracket body portion 231 of the second hinge mounting bracket 230. Accordingly, the bracket body portion 231 may be disposed to face a front surface of the second door 30, and the plate body portion 241 may be disposed to face an upper surface of the second door 30.

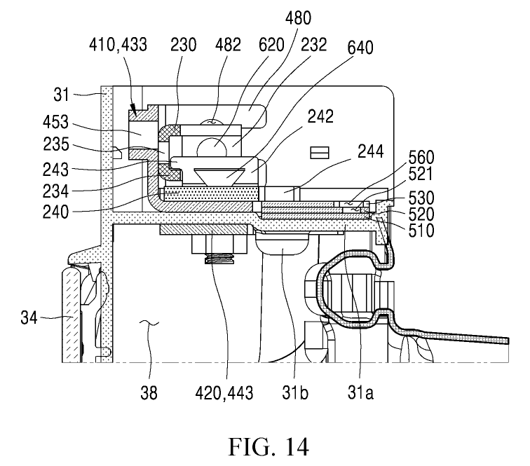

A plate bent portion 242 that is bent upward and extends may be formed at one side end of the plate body portion 241. A catch portion 243 that protrudes forward may be formed at an upper end of the plate bent portion 242 facing forward. Referring to FIG. 14, when the second hinge mounting plate 240 is fastened to the second hinge mounting bracket 230, the catch portion 243 protruding forward may be caught on an upper surface of the catch 234 protruding rearward, thereby enabling engagement by a catch or a hook. That is, the catch portion 243 of the second hinge mounting plate 240 may press the catch 234 of the second hinge mounting bracket 230 in a downward direction, thereby increasing the fastening force between the second hinge mounting bracket 230 and the second upper cap deco 31. When the catch portion 243 is fastened to the catch 234, the catch portion 243 may be disposed adjacent to the bracket bent portion 232. In this case, since the step adjustment member 620 capable of repeated fastening and unfastening is fastened to the bracket bent portion 232, the catch portion 243 is preferably spaced apart from the end portion of the step adjustment member 620 passing through the bracket bent portion 232 by a predetermined distance or disposed below the step adjustment member 620.

One or more fastening holes 246 passing through the plate body portion 241 in the vertical direction may be formed in the plate body portion 241. The fastening holes 246 may be formed in the shape of elongated holes extending in the horizontal direction through which the step adjustment member 620 is fastened and unfastened. That is, the extension direction of the elongated hole of the fastening hole 246 may correspond to the horizontal movement direction of the second door 30 for horizontal step adjustment. A pair of fastening holes 246 may be disposed side by side in the horizontal direction. The second direction fastening member 640 fastened and unfastened in the vertical direction, which is a second direction orthogonal to the first direction, may be fastened to the fastening hole 246. For example, the second direction fastening member 640 may be a screw member or a bolt member.

One or more protrusions 244 protruding rearward from one surface of the plate body portion 241 may be formed on the plate body portion 241. The protrusion 244 may protrude horizontally from a rear surface of the plate body portion 241. For example, a pair of protrusions 244 may be formed with a pair of fastening holes 246 interposed therebetween. The fastening hole 245 passing through the protrusion 244 in the vertical direction may be formed in each protrusion 244.

One or more step adjustment sheets 500 may be disposed below the plate body portion 241. For example, the step adjustment sheet 500 may include a first step adjustment sheet 510, a second step adjustment sheet 520, and a third step adjustment sheet 530 that are stacked sequentially from the bottom to the top. Each step adjustment sheet 500 may be formed to generally have a plate shape. For example, the step adjustment sheet 500 may have a plate shape in which a length in the horizontal direction is greater than a length in the front-rear direction.

A pair of slot guide portions 540 formed to pass through the first step adjustment sheet 510 in the vertical direction may be formed adjacent to both horizontal edges of the first step adjustment sheet 510. The slot guide portions 540 may be extended and penetrated in one direction along the front-rear direction. In the same manner, the pair of slot guide portions 540 may also be formed in each of the second step adjustment sheet 520 and the third step adjustment sheet 530. The slot guide portion 540 may be formed to vertically overlap the fastening hole 245 formed in a protrusion 244 of the plate body portion 241. Accordingly, a plurality of step adjustment sheets 500 may be aligned and stacked such that the fastening hole 245 of each slot guide portion 540 and the protrusion 244 overlap each other.

The step adjustment sheet 500 may be fixed to the lower surface of the second hinge mounting plate 240 by a moving guide member 610 vertically passing through the slot guide portion 540 and the fastening hole 245 of the protrusion 244. For example, the moving guide member 610 may be a rivet member. The moving guide member 610 can further strengthen the bonding force by fixing the step adjustment sheet 500 to the lower surface of the second hinge mounting plate 240 by a rivet fastening method. The moving guide member 610 can effectively prevent the step adjustment sheet 500 from being removed by forming the diameters of both ends thereof to be greater than the diameters of the slot guide portion 540 and the fastening hole 245.

In addition, the moving guide member 610 may guide the movement of each step adjustment sheet 500 in the front-rear direction. Each step adjustment sheet 500 may move horizontally along the moving guide member 610. For example, each step adjustment sheet 500 may be inserted and withdrawn in a sliding manner along the slot guide portion 540 which is opened in the front-rear direction using a pair of moving guide members 610 disposed on both sides as a single axis. In this way, as the plurality of step adjustment sheets 500 are horizontally inserted and withdrawn in a sliding manner, the step adjustment sheets 500 may be moved selectively and independently.

In this way, the refrigerator according to one embodiment of the present disclosure is configured such that the step adjustment sheet for adjusting the vertical step of the door moves horizontally or is inserted and withdrawn in a sliding manner, thereby enabling convenient and smooth vertical step adjustment even in narrow installation environments.

In addition, in the refrigerator according to one embodiment of the present disclosure, by guiding movement of the step adjustment sheet so that the step adjustment sheet moves only along the designated path, the movement trajectory of the step adjustment sheet can be accurately guided. Accordingly, the step adjustment sheet can be prevented from being unnecessarily removed or damaged during the step adjustment process, and stable and repeated step adjustment can be achieved even in a narrow installation environment.

For example, the slot guide portion 540 may be formed to have a closed loop shape that is closed not only in the horizontal direction but also in the front-rear direction. Accordingly, the step adjustment sheet 500 can be prevented from being removed from the second hinge mounting plate 240 during the process of being inserted and withdrawn in the front-rear direction. Accordingly, the step adjustment sheet 500 can be prevented from being lost. In addition, repeatability that may be reproduced in the same manner and operational stability can be improved even when insertion and withdrawal of the step adjustment sheet 500 are repeatedly performed. In this case, the length of the slot guide portion 540 in the front-rear direction may define a maximum insertion and withdrawal distance of the step adjustment sheet 500. In this case, the direction in which the step adjustment sheet 500 is withdrawn may be defined as a direction toward the rear of the second door 30, and the direction in which the step adjustment sheet 500 is inserted may be defined as a direction toward the front of the second door 30.

In a state in which the step adjustment sheets 500 are inserted into the lower surface of the second hinge mounting plate 240, the step adjustment sheets 500 may be disposed to vertically overlap the fastening hole 246 of the plate body portion 241. In this case, since the fastening hole 246 is penetrated by the second direction fastening member 640, the step adjustment sheet 500 may also interfere with the second direction fastening member 640. Accordingly, the step adjustment sheet 500 may include the relief portion 550 that has an opening that vertically overlaps the fastening hole 246. That is, in a state in which the step adjustment sheet 500 is fully inserted, the fastening hole 246 and the relief portion 550 may be disposed to vertically overlap each other. The relief portion 550 may be formed in pairs in a front region of the step adjustment sheet 500. Accordingly, even in a state in which the step adjustment sheet 500 is fully inserted, the second direction fastening member 640 passing through the fastening hole 246 may extend downward through the relief portion 550. In this way, even when the step adjustment sheet 500 is inserted and withdrawn in the front-rear direction due to the relief portion 550 of the step adjustment sheet 500, the step adjustment sheet 500 may be freely inserted and withdrawn without interfering with the second direction fastening member 640.

In a rear region, which is the direction in which each step adjustment sheet 500 is withdrawn, withdrawal holes 511, 521, and 531 passing through the rear region in the vertical direction may be formed. For example, a first withdrawal hole 511, a second withdrawal hole 521, and a third withdrawal hole 531 may be formed in the first step adjustment sheet 510, the second step adjustment sheet 520, and the third step adjustment sheet 530, respectively. In this case, the first withdrawal hole 511, the second withdrawal hole 521, and the third withdrawal hole 531 may be formed so as not to overlap each other in the vertical direction. For example, the first withdrawal hole 511 may be disposed to overlap the relief portion 550 disposed on one side thereof in the front-rear direction; the second withdrawal hole 521 may be disposed between a pair of relief portions 550; and the third withdrawal hole 531 may be disposed to overlap the relief portion 550 disposed on the other side in the front-rear direction.

In a stacked state in which the plurality of step adjustment sheets 500 overlap each other, the first withdrawal hole 511, the second withdrawal hole 521, and the third withdrawal hole 531 may all be exposed to the outside in an upward direction. To this end, the second step adjustment sheet 520 and the third step adjustment sheet 530, which are disposed above the first step adjustment sheet 510, may have a cutout portion 560 having an open region overlapping the first withdrawal hole 511 in the vertical direction. In addition, in the third step adjustment sheet 530 disposed above the second step adjustment sheet 520, the cutout portion 560 having the open region overlapping the second withdrawal hole 521 in the vertical direction may be formed. For example, the second step adjustment sheet 520 may have one cutout portion 560, and the third step adjustment sheet 530 may have two cutout portions 560.

In addition, in a state in which the step adjustment sheet 500 is fully inserted, the first withdrawal hole 511, the second withdrawal hole 521, and the third withdrawal hole 531 may be disposed so as not to overlap the protrusion 244 of the second hinge mounting plate 240. For example, the first withdrawal hole 511, the second withdrawal hole 521, and the third withdrawal hole 531 may be disposed between a pair of protrusions 244. In this case, the first withdrawal hole 511, the second withdrawal hole 521, and the third withdrawal hole 531 may be arranged side by side with the pair of protrusions 244 in the horizontal direction.

As described above, the first withdrawal hole 511, the second withdrawal hole 521, and the third withdrawal hole 531 formed in each step adjustment sheet 500 may serve as guide holes used to independently insert and withdraw each step adjustment sheet 500. For example, a user may insert and withdraw each step adjustment sheet 500 using a mechanism inserted into each withdrawal hole. Accordingly, the user may insert the mechanism into the first withdrawal hole 511 when inserting and withdrawing the first step adjustment sheet 510, insert the mechanism into the second withdrawal hole 521 when inserting and withdrawing the second step adjustment sheet 520, and insert the mechanism into the third withdrawal hole 531 when inserting and withdrawing the third step adjustment sheet 530.

Meanwhile, a gap adjustment sheet 250 may be disposed between the bracket coupling portion 233 of the second hinge mounting bracket 230 and the second hinge mounting plate 240. The gap adjustment sheet 250 may be disposed on an upper surface of the second hinge mounting plate 240 and formed to substantially correspond to the bracket coupling portion 233. The gap adjustment sheet 250 may be formed in a plate shape having a predetermined thickness in the vertical direction. The second hinge mounting plate 240 and the second hinge mounting bracket 230 may be fastened to each other while being spaced apart from each other by a thickness of the gap adjustment sheet 250. Accordingly, interference between the hinge member and the second hinge mounting plate 240 can be prevented while the first hinge member 211 or the second hinge member 212 is folded or unfolded. In addition, when the door sags due to its own weight during long-term use of the refrigerator 1, interference may occur as a distance between the hinge member 110 and the second hinge mounting plate 240 becomes smaller than a distance at the time of initial installation. Accordingly, the gap adjustment sheet 250 may create a buffer region of a predetermined distance between the hinge member 110 and the second hinge mounting plate 240 in advance, in consideration of such door sagginess, thereby improving operational reliability even when the refrigerator is used for a long time.

A through-hole 251 through which the second direction fixing member 650 passes may be formed in the gap adjustment sheet 250. In addition, the through-hole 251 may also be formed in the second hinge mounting plate 240 to correspond to the through-hole 251 of the gap adjustment sheet 250. Accordingly, the second direction fixing member 650 vertically passing through the second hinge mounting bracket 230 and the second hinge mounting plate 240 may also be fastened with the second hinge mounting bracket 230 and the second hinge mounting plate 240 through the gap adjustment sheet 250.

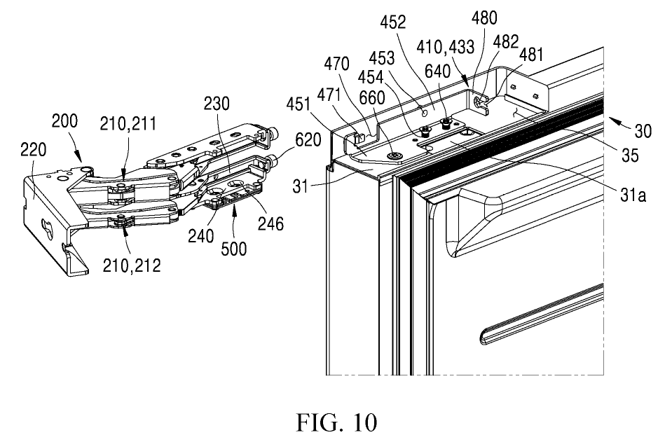

Meanwhile, referring to FIG. 10, the lower door upper outer bracket 433, which is the door outer bracket 410, may be mounted on the second upper cap deco 31 that finishes the upper surface of the second door 30. For example, the second hinge mounting portion 35 may be formed on the second upper cap deco 31 in a form in which one side surface and rear surface adjacent to the second hinge assembly 200 are open and the front surface and other side surface thereof are closed. The lower door upper outer bracket 433 may be disposed on the second hinge mounting portion 35.

The lower door upper outer bracket 433 may include a first plate 451 fastened to an upper outer surface of the second upper cap deco 31, and a second plate 452 bent upward from a front end of the first plate 451. A fastening hole 454 through which the second direction fastening member 640 passes in the front-rear direction and is fastened may be formed in the first plate 451. A lower door upper inner bracket 443, which is the door inner bracket 420, may be disposed on a lower inner surface of the second upper cap deco 31. In this case, the second direction fastening member 640 may be fastened to the lower door upper inner bracket 443 through the fastening hole 454 of the first plate 451. Accordingly, the second direction fastening member 640 can further improve the fastening force between the second hinge assembly 200 and the second door 30 by fastening the second hinge mounting plate 240, the lower door upper outer bracket 433, the second upper cap deco 31, and the lower door upper inner bracket 443. To improve the fastening force between the lower door upper outer bracket 433 and the lower door upper inner bracket 443, a fastening member 660 passing through and the lower door upper outer bracket 433, the second upper cap deco 31, and the lower door upper inner bracket 443 and fastening the same may be additionally provided.

A second upper recess 31a recessed downward by a predetermined thickness may be formed in the second hinge mounting portion 35. The second upper recess 31a is a region in which the step adjustment sheet 500 withdrawn from the second hinge mounting plate 240 is stored and seated and may be formed to substantially correspond to the step adjustment sheet 500. To allow the step adjustment sheet 500 to be stored in the second upper recess 31a without interference, the first plate 451 may be formed to expose the second upper recess 31a to the outside without overlapping the second upper recess 31a in the vertical direction.

In this way, in the refrigerator according to one embodiment of the present disclosure, since the moved step adjustment sheet may be stored in the recess formed in the door, the step adjustment sheet is neatly stored in the door without protruding outward, thereby not only increasing space utilization and improving work convenience in narrow spaces, but also effectively preventing the loss of the step adjustment sheet.

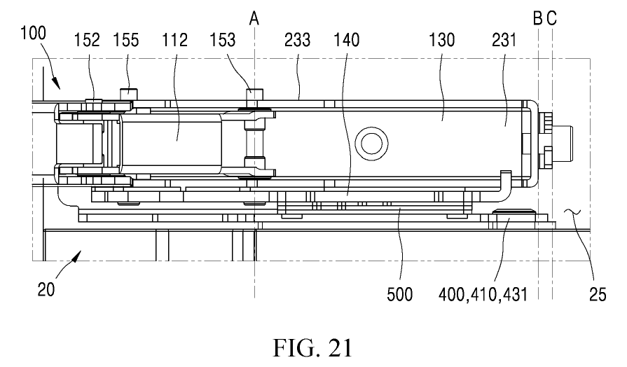

Referring further to FIG. 21, the step adjustment sheet 500 may be disposed to correspond to the bracket body portion 231 of the hinge mounting bracket 130. For example, based on the front view of the first hinge assembly (see FIG. 21), the step adjustment sheet 500 may be disposed to correspond to a horizontal extension of the bracket body portion 231. For example, the step adjustment sheet 500 may be disposed between a first boundary line A in which the third rotational shaft 153 of the first hinge member 110 is located, and a second boundary line B, which is an outermost region of the hinge mounting bracket 130 in the horizontal direction. In this case, since a third boundary line C, which is an outermost region of the upper door upper outer bracket 431, may be located further outward than the second boundary line B, the step adjustment sheet 500 may be disposed between the first boundary line A in which the third rotational shaft 153 of the first hinge member 110 is located, and the third boundary line C, which is an outermost region of the upper door upper outer bracket 431, in the horizontal direction. Accordingly, the step adjustment sheet 500 further extending in the horizontal direction than in the front-rear direction may be disposed to correspond to the bracket body portion 231 extending in the horizontal direction, and thus may be inserted and withdrawn without interference with other components.

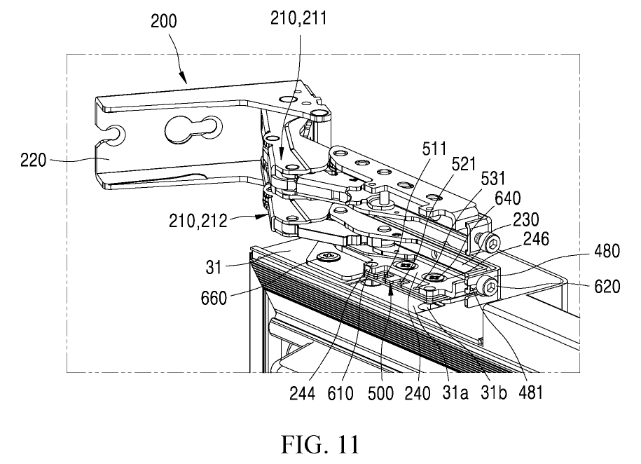

Referring to FIG. 11, a relief hole 31b recessed further downward than the second upper recess 31a may be formed in the second upper recess 31a. The relief hole 31b may be formed to vertically overlap the moving guide member 610 fastened to the protrusion 244 of the second hinge mounting plate 240 in a state in which the second hinge assembly 200 is mounted on the second door 30. According to the method of fastening the moving guide member 610, the moving guide member 610 may be fastened to protrude further downward than a lower surface of the protrusion 244. Accordingly, when the vertical height of the protrusion 244 is changed during the process of adjusting the vertical step of the second door 30, the protrusion 244 may be closer to the second upper recess 31a. In this case, as the relief hole 31b is formed below the protrusion 244, at least a portion of the moving guide member 610 protruding further downward than the lower surface of the protrusion 244 may be stored in the relief hole 31b. In this way, the moving guide member 610 may not interfere with the second upper recess 31a, thereby preventing damage caused by contact between components and improving operational reliability.

The second plate 452 bent upward from the front end of the first plate 451 may be fastened to the bracket body portion 231 of the second hinge mounting bracket 230. Accordingly, the second hinge mounting plate 240 of the second hinge assembly 200 may be fastened to the first plate 451 of the lower door upper outer bracket 433, and the second hinge mounting bracket 230 may be fastened to the second plate 452 of the lower door upper outer bracket 433. The fastening hole 453 passing through the second plate 452 in the front-rear direction may be formed in the second plate 452. The fastening hole 453 of the second plate 452 may be aligned with the screw hole 235 of the second hinge mounting bracket 230 and fastened by the first direction fastening member 630 fastened and unfastened in the front-rear direction. For example, the first direction fastening member 630 may be a screw member or a bolt member.

For example, the second hinge mounting bracket 230 of the first hinge member 211 and the second plate 452 of the upper door lower outer bracket 432 may be fastened by the first direction fastening member 630, and the second hinge mounting bracket 230 of the second hinge member 212 and the second plate 452 of the lower door upper outer bracket 433 may also be fastened by the first direction fastening member 630 provided separately. As another example, the second hinge mounting bracket 230 of the first hinge member 211 and the second plate 452 of the upper door lower outer bracket 432 may be fastened by the first direction fastening member 630, and the second hinge mounting bracket 230 of the second hinge member 212 and the second plate 452 of the lower door upper outer bracket 433 may not be fastened by the first direction fastening member 630 provided separately.

The inner diameter of the screw hole 235 formed in the second hinge mounting bracket 230 may be formed to be greater than the inner diameter of the fastening hole 453 formed in the second plate 452. Accordingly, the first direction fastening member 630 may be fastened to the fastening hole 453 of the second plate 452 but is not fastened to the screw hole 235 of the second hinge mounting bracket 230 and may simply pass therethrough. Accordingly, when a step of the second door 30 is adjusted in vertical and horizontal directions, the first direction fastening member 630 may freely move in the vertical and horizontal directions within the screw hole 235 without interference in a state of being fastened to the fastening hole 453 of the second plate 452. This allows only the second door 30 to move freely in a state in which the second hinge assembly 200 is fixed to the second hinge mounting bracket 230 when the step of the second door 30 is adjusted. In addition, the inner diameter of the screw hole 235 formed in the second hinge mounting bracket 230 connected to the first hinge member 210 based on the second hinge assembly 200 may be formed to be greater than the inner diameter of the screw hole 235 formed in the second hinge mounting bracket 230 connected to the second hinge member 212. In this case, the first direction fastening member 630 is used only for the first hinge member 210, and the first direction fastening member 630 is not used for the second hinge member 220, thereby reducing the number of components and achieving cost reduction.

The insertion hole 470 having a partially open region may be formed in a front surface of the second plate 452. The insertion hole 470 may be formed adjacent to the portion where the second hinge assembly 200 is fastened. The hook portion 471 may be formed on the second plate 452. For example, the hook portion 471 may be formed to overlap the insertion hole 470 in the front-rear direction. The hook portion 471 may protrude rearward from one side of the insertion hole 470 adjacent to the portion where the second hinge assembly 200 is fastened and may be bent and protruded toward the other side of the insertion hole 470. In this case, a length of the hook portion 471 protruding in the horizontal direction is preferably formed to be shorter than a length of the insertion hole 470 in the horizontal direction.

A guide bent portion 480 bent rearward in the vertical direction at one end of the second plate 452 may be formed. The guide bent portion 480 may be bent rearward at the one end of the second plate 452 that is far from the direction in which the second hinge assembly 200 is located. The guide bent portion 480 may be bent orthogonal to the second plate 452. Accordingly, the guide bent portion 480 may be bent in the same direction to face the bracket bent portion 23 of the second hinge mounting bracket 230.

A through-hole 481 passing through the guide bent portion 480 in the horizontal direction may be formed in the guide bent portion 480. The through-hole 481 may have a shape that is cut such that a rear portion thereof is open. That is, the through-hole 481 may be cut from a rear end of the guide bent portion 480 such that the open region thereof may be continuously formed. Through the through-hole 481 having the open rear portion in this way, the step adjustment member 620 fastened to the second hinge mounting bracket 230 of the second hinge assembly 200 may be inserted by passing through the through-hole 481 in the front-rear direction. However, the present disclosure is not limited thereto, and after the second hinge assembly 200 is mounted on the lower door upper outer bracket 433, the step adjustment member 620 may be fastened to the second hinge mounting bracket 230 to pass through the through-hole 481 in the horizontal direction.

The diameter of the head portion 621 of the step adjustment member 620 may be formed to be greater than the diameter of the through-hole 481 of the guide bent portion 480. Accordingly, in a state in which the second hinge assembly 200 is mounted on the lower door upper outer bracket 433, a shaft portion 622 of the step adjustment member 620 may pass through the through-hole 481 of the guide bent portion 480, but the head portion 621 of the step adjustment member 620 may not pass through the through-hole 481 of the guide bent portion 480 and may be located outside the guide bent portion 480. That is, in a state in which the second hinge assembly 200 is mounted on the lower door upper outer bracket 433, the second hinge assembly 200 and the shaft portion 622 of the step adjustment member 620 may be disposed in a direction toward an interior of the guide bent portion 480 with respect to the guide bent portion 480, and the head portion 621 of the step adjustment member 620 may be disposed in a direction toward an exterior of the guide bent portion 480 and exposed to the outside. Accordingly, the user can easily rotate the step adjustment member 620 using the head portion 621 of the step adjustment member 620 exposed to the outside. The head portion 621 may be located to be in contact with an outer surface of the guide bent portion 480. The step of the second door 30 may be adjusted in the horizontal direction by adjusting an insertion distance of the shaft portion 622 through the fastening and unfastening of the step adjustment member 620 in the horizontal direction.

In this case, the step of the door in the horizontal direction may be adjusted by changing the location of the second direction fastening member 640 in the fastening hole 246 having an elongated hole extending in the horizontal direction. For example, when the second door 30 moves outward from the refrigerator 1 in the horizontal direction, the second direction fastening member 640 may also be moved to be located at one end of the fastening hole 246 adjacent to the outer side of the refrigerator 1. In this case, the distance between the guide bent portion 480 and the bracket bent portion 232 may be reduced. In addition, when the second door 30 moves in the direction toward the center of the refrigerator 1, that is, toward the interior thereof, in the horizontal direction, the second direction fastening member 640 may also be moved to be located at the other end of the fastening hole 246 adjacent to the inner side of the refrigerator 1. In this case, the distance between the guide bent portion 480 and the bracket bent portion 232 may be increased. In this case, the step adjustment member 620 may be fastened or unfastened to adjust the distance between the guide bent portion 480 and the bracket bent portion 232. In a state in which the second direction fastening member 640 is fastened, the step adjustment member 620 may be tightened to the extent that it may be in contact with the guide bent portion 480, thereby further increasing the fastening force between the hinge assembly and the door mounting bracket.

An extension opening hole 482 extending in the vertical direction may be formed in the through-hole 481. The extension opening hole 482 may extend in one direction along the vertical movement direction of the second door 30. For example, the shaft portion 622 of the step adjustment member 620 passing through the through-hole 481 of the guide bent portion 480 may move in the vertical direction along the extension opening hole 482. Accordingly, the outer diameter of the shaft portion 622 of the step adjustment member 620 may be formed to be smaller than the inner diameter of the extension opening hole 482. Accordingly, the extension opening hole 482 of the guide bent portion 480 may serve to guide the vertical movement of the second hinge assembly 200 to which the step adjustment member 620 is fastened.

In this way, in the refrigerator according to one embodiment of the present disclosure, since the through-hole of the door mounting bracket through which the step adjustment member for adjusting the door step in the horizontal direction passes includes the extension opening hole extending in the vertical movement direction of the door, the vertical and horizontal step adjustments of the door may be substantially controlled integrally at the same location, thereby further improving workability and intuitiveness for step adjustment.

Referring to FIG. 11, it can be seen that the second hinge member 212 of the second hinge assembly 200 is fastened to the lower door upper outer bracket 433 and a plurality of step adjustment sheets 500 are all inserted. In this case, the plurality of step adjustment sheets 500 may be disposed between the second hinge mounting plate 240 and the lower door upper outer bracket 433 and fixed by being pressed downward by the second direction fastening member 640. In addition, the head portion 621 of the step adjustment member 620 may be in a state of being raised to an uppermost end of the extension opening hole 482 of the guide bent portion 480. Accordingly, the second door 30 may be in a state of being adjusted to be located at the maximum height in the vertical direction.

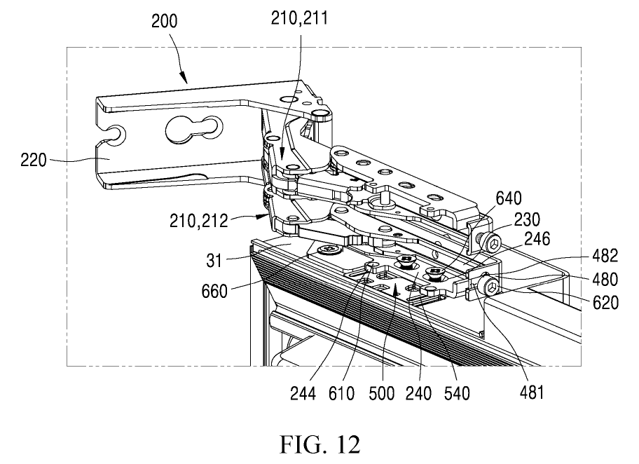

Meanwhile, referring to FIGS. 12-14, it can be seen that the plurality of step adjustment sheets 500 are all withdrawn to adjust the step of the second door 30 and stored in the second upper recess 31a. Accordingly, the second hinge mounting plate 240 and the lower door upper outer bracket 433 may be in direct contact. For example, to facilitate the smooth withdrawal of the step adjustment sheets 500, it is preferable to slightly release the second direction fastening member 640 that is fully fastened. Accordingly, the downward pressing force applied to the step adjustment sheets 500 can be reduced, thereby making it easier to withdraw the step adjustment sheets 500. When the plurality of step adjustment sheets 500 are all withdrawn, the head portion 621 of the step adjustment member 620 may be in a state of being lowered to the lowest end of the extension opening hole 482 of the guide bent portion 480. Accordingly, the second door 30 may be in a state of being adjusted to be located at the minimum height in the vertical direction. After the plurality of step adjustment sheets 500 are all withdrawn and stored in the second upper recess 31a, the second direction fastening member 640 may be fully fastened by rotation, thereby increasing the fastening force between the second hinge assembly 200 and the second door 30.

Referring to FIG. 14, the second direction fastening member 640 may pass through the second hinge mounting plate 240 and fasten the lower door upper outer bracket 433, the upper surface of the second upper cap deco 31, and the lower door upper inner bracket 443. Accordingly, the lower door upper inner bracket 443 disposed within the second insulation space 38 of the second door 30 formed by the front plate 33, the door liner, and the second upper cap deco 31 may have a strong fastening force with the lower door upper outer bracket 433 with the upper surface of the second upper cap deco 31 interposed therebetween by the second direction fastening member 640.

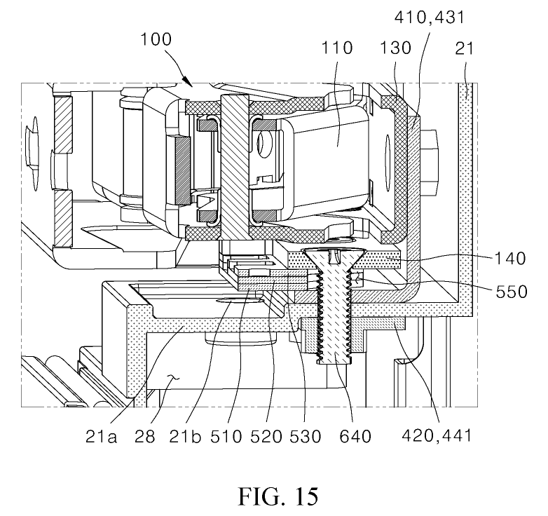

Hereinafter, a method of adjusting a vertical step of the first door 20 provided with the first hinge assembly 100 according to one embodiment will be described with further reference to FIGS. 15-19.

FIG. 15 illustrates a state in which the first step adjustment sheet 510, the second step adjustment sheet 520, and the third step adjustment sheet 530 are all inserted, and in this case, the first door 20 may be located at the minimum height that may be adjusted in the vertical direction.

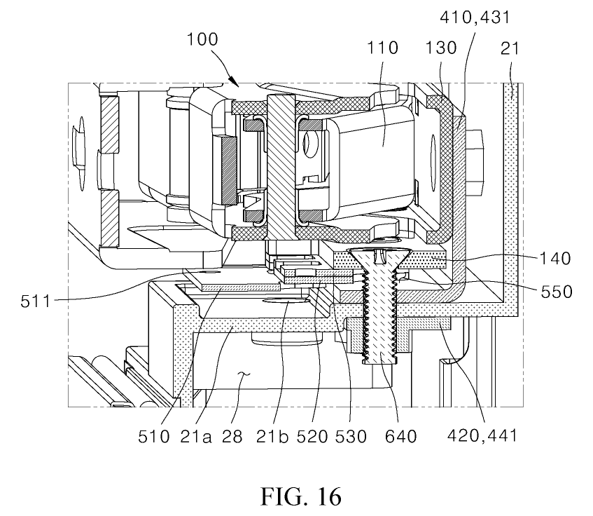

FIG. 16 illustrates a state in which the first step adjustment sheet 510 is withdrawn and the second step adjustment sheet 520 and the third step adjustment sheet 530 are inserted. When some of the plurality of step adjustment sheets 500 are withdrawn, the step adjustment sheet that is closer to the upper or lower surface of the door than the hinge mounting plate may be withdrawn preferentially. In addition, when some of the plurality of step adjustment sheets 500 are inserted, the step adjustment sheet that is closer to the hinge mounting plate than the upper or lower surface of the door may be inserted preferentially.

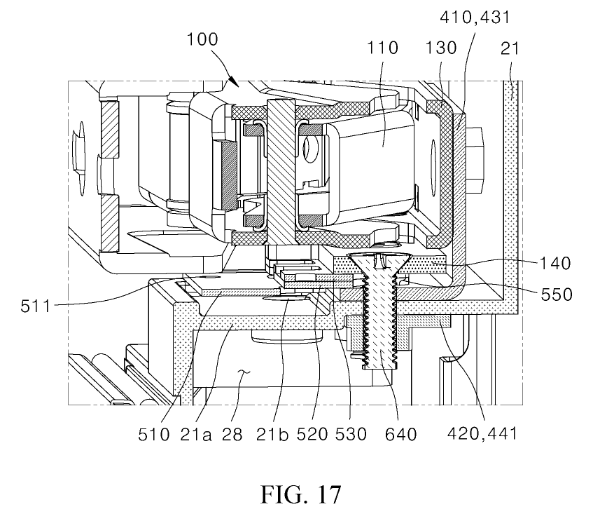

For example, in the case of the first hinge assembly 100, the first step adjustment sheet 510 may be withdrawn preferentially. To this end, the first step adjustment sheet 510 may be withdrawn using the first withdrawal hole 511 formed in the first step adjustment sheet 510. When the first step adjustment sheet 510 is withdrawn in this way, a predetermined gap may be formed between the second step adjustment sheet 520 and the upper door upper outer bracket 431. Accordingly, referring to FIG. 17, the second direction fastening member 640 may be rotated in the fastening direction to eliminate the gap, thereby bringing the second step adjustment sheet 520 and the upper door upper outer bracket 431 into contact with each other. In this case, the first step adjustment sheet 510 withdrawn rearward may be disposed on the first upper recess 21a to be spaced apart therefrom by a predetermined distance and to overlap the same in the vertical direction.

In this way, by withdrawing the first step adjustment sheet 510, the step of the first door 20 may be adjusted in the vertical direction by the vertical thickness of the first step adjustment sheet 510. That is, the first door 20 may be moved upward by the vertical thickness of the first step adjustment sheet 510.

The insertion and withdrawal of the step adjustment sheet 500 of the first hinge assembly 100 fastened to the upper portion of the first door 20 and the insertion and withdrawal of the step adjustment sheet 500 of the first hinge member 211 of the second hinge assembly 200 fastened to the lower portion of the first door 20 may be synchronized. For example, since the first hinge assembly 100 supports the upper portion of the first door 20 and the first hinge member 211 of the second hinge assembly 200 supports the lower portion of the first door 20, the movement distance of the first door 20 moving upward or downward can be accurately and finely controlled by inserting or withdrawing the step adjustment sheets located in each hinge assembly in equal numbers.

Likewise, the insertion and withdrawal of the step adjustment sheet 500 of the second hinge member 212 of the second hinge assembly 200 fastened to the upper portion of the second door 30 and the insertion and withdrawal of the step adjustment sheet 500 of the third hinge assembly 300 fastened to the lower portion of the second door 30 may be synchronized. For example, since the second hinge member 212 of the second hinge assembly 200 supports the upper portion of the second door 30 and the third hinge assembly 300 supports the lower portion of the second door 30, the movement distance of the second door 30 moving upward or downward can be accurately and finely adjusted by inserting or withdrawing the step adjustment sheets located in each hinge assembly in equal numbers.

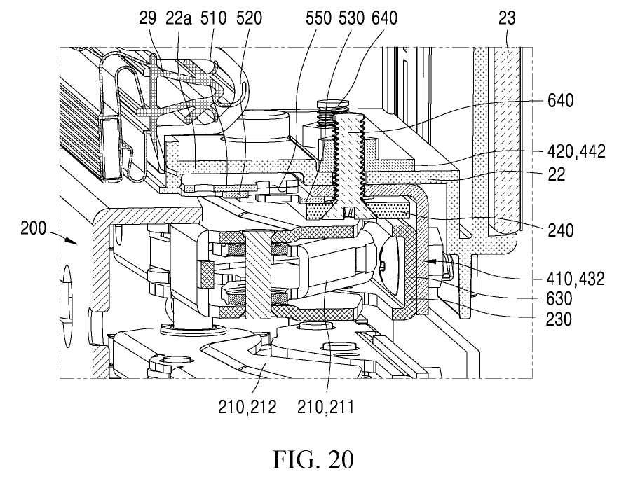

For example, referring to FIG. 20, when the first step adjustment sheet 510 and the second step adjustment sheet 520 among the step adjustment sheets 500 of the first hinge assembly 100 are withdrawn, it can be seen that the first step adjustment sheet 510 and the second step adjustment sheet 520 among the step adjustment sheets 500 of the second hinge assembly 200 are withdrawn in the same manner. In this case, the first step adjustment sheet 510 and the second step adjustment sheet 520 may be disposed to be spaced apart from the first lower recess 22a by a predetermined distance and to overlap the first lower recess 22a in the vertical direction. In this case, the first step adjustment sheet 510 may be withdrawn first, and then the second step adjustment sheet 520 may be withdrawn. The second direction fastening member 640 may pass through the second hinge mounting plate 240 and fasten the upper door lower outer bracket 432, the lower surface of the first lower cap deco 22, and the upper door lower inner bracket 442. Accordingly, the upper door lower inner bracket 442 disposed within the first insulation space 28 of the first door 20 formed by the front plate 23, a gasket portion 29 of the door liner, and the first lower cap deco 22 may be firmly fastened to the upper door lower outer bracket 432 with the lower surface of the first lower cap deco 22 interposed therebetween by the second direction fastening member 640.

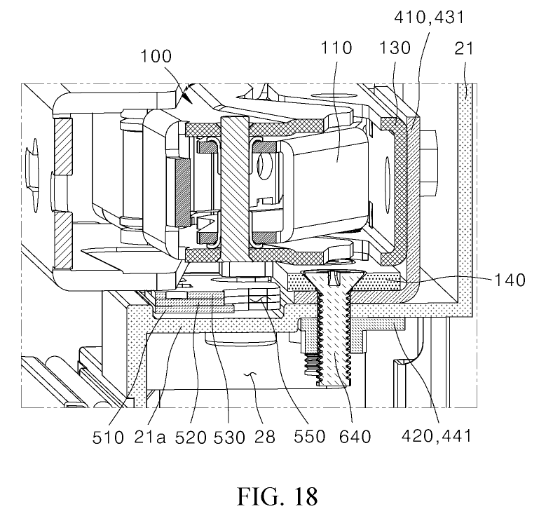

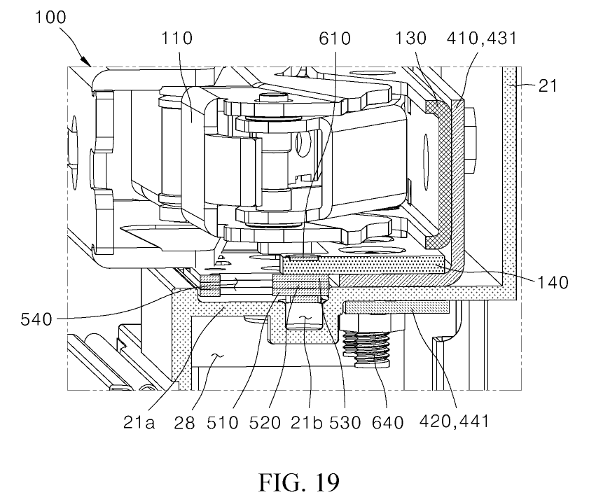

Referring to FIGS. 18 and 19, it can be seen that the first step adjustment sheet 510, the second step adjustment sheet 520, and the third step adjustment sheet 530 are all withdrawn and stored in the first upper recess 21a. In this case, the order in which the step adjustment sheets 500 are withdrawn is the first step adjustment sheet 510, the second step adjustment sheet 520, and the third step adjustment sheet 530. The first step adjustment sheet 510, the second step adjustment sheet 520, and the third step adjustment sheet 530 may be seated and stored in the first upper recess 21a. After the first step adjustment sheet 510, the second step adjustment sheet 520, and the third step adjustment sheet 530 are all withdrawn, when the second direction fastening member 640 is further tightened by rotation, the first hinge mounting plate 140 may be fastened to be in contact with the upper door upper outer bracket 431. That is, the second direction fastening member 640 may pass through the first hinge mounting plate 140, the upper door upper outer bracket 431, the first upper cap deco 21, and the upper door upper inner bracket 441 and fasten the same. Accordingly, the first door 20 may be moved upward by the total vertical thickness of the first step adjustment sheet 510, the second step adjustment sheet 520, and the third step adjustment sheet 530, thereby enabling vertical step adjustment.

Meanwhile, the moving guide member 610 for guiding movement of the step adjustment sheets 500 in the front-rear direction may pass through the slot guide portions 540 of the first step adjustment sheet 510, the second step adjustment sheet 520, and the third step adjustment sheet 530 and protrude by a predetermined thickness further downward than a lowest surface of the first step adjustment sheet 510. For example, the moving guide member 610 may protrude further downward than the lower surface of the first step adjustment sheet 510 located on the lowest surface thereof to prevent separation of the first step adjustment sheet 510, the second step adjustment sheet 520, and the third step adjustment sheet 530. In this case, the diameter of the lowest surface of the moving guide member 610 protruding outward may be set to be greater than the horizontal diameter of the slot guide portion 540. Accordingly, the moving guide member 610 can effectively prevent separation of the first step adjustment sheet 510, the second step adjustment sheet 520, and the third step adjustment sheet 530. The moving guide member 610 protruding further than the lowest surface of the first step adjustment sheet 510 may be stored in the relief hole 21b.

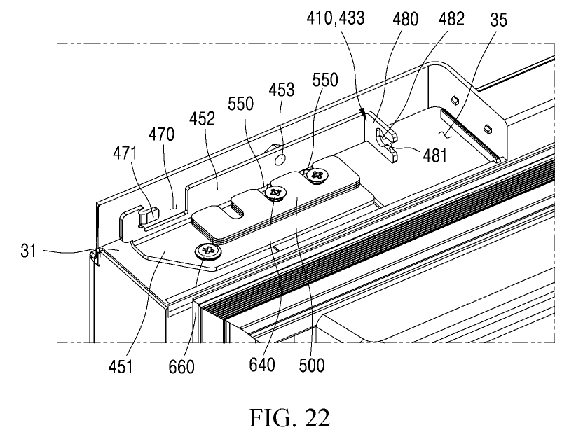

Referring to FIG. 22, the step adjustment sheet 500 according to another embodiment may be described. A plurality of step adjustment sheets 500 may be formed in a form that is not constrained by a hinge assembly and is completely separated. For example, the step adjustment sheet 500 may generally have a plate shape and may be formed to include a relief portion 550 for preventing interference with the second direction fastening member 640 during insertion and withdrawal. Accordingly, each step adjustment sheet 500 may be selectively removed or added in consideration of a vertical step to be adjusted.

In this way, in the refrigerator according to one embodiment of the present disclosure, more precise vertical step adjustment of the door can be achieved by allowing the step adjustment sheet to be freely separated from the hinge assembly, thereby freely adjusting the number of stacked step adjustment sheets. In addition, when the step adjustment sheet is damaged, only the damaged step adjustment sheet can be easily replaced, thereby enabling ease of replacement and a reduction in maintenance costs.

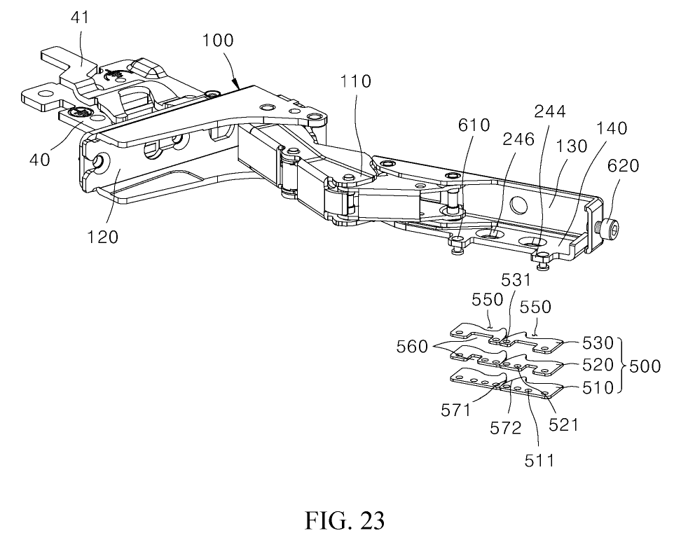

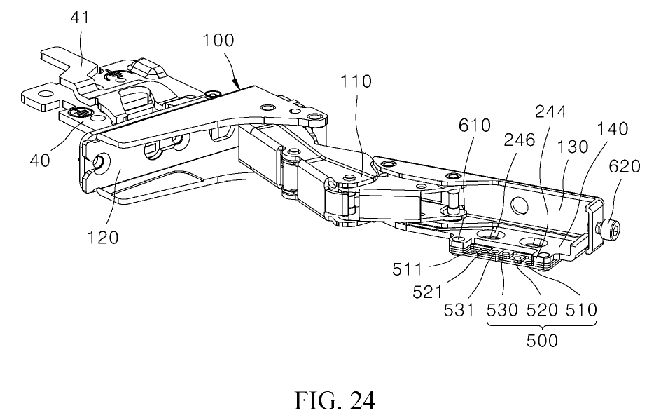

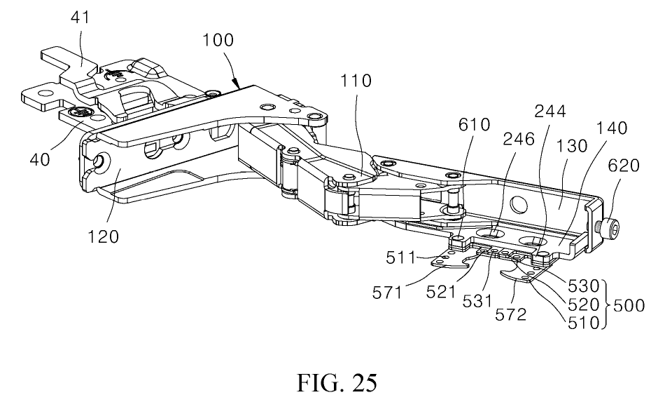

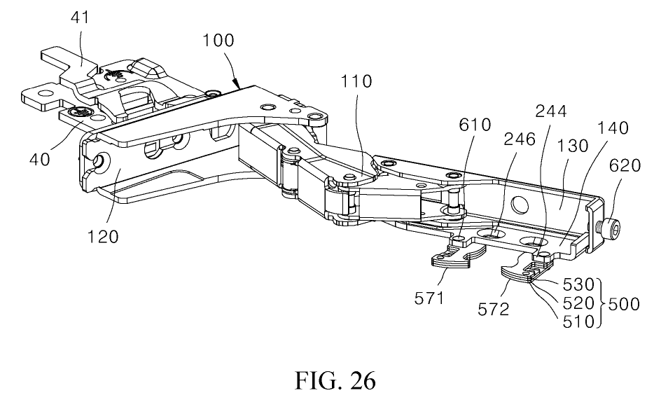

Referring to FIGS. 23-26, the step adjustment sheet 500 according to still another embodiment may be described.

According to still another embodiment, the step adjustment sheet 500 may be inserted and withdrawn by rotating about a single axis using the moving guide member 610 as a rotational axis. The step adjustment sheet 500 may be provided in pairs. For example, the first step adjustment sheet 510 may be provided in pairs that rotates about one axis of the moving guide member 610 at one side and rotates about one axis of the moving guide member 610 at the other side. The first step adjustment sheet 510 at the left and the first step adjustment sheet 510 at the right may be disposed side by side so as to be horizontal to each other.

For example, the first step adjustment sheet 510 at the left and the first step adjustment sheet 510 at the right in the horizontal direction may each include a first surface 571 and a second surface 572 that are in contact with each other in the inserted state. The first surface 571 and the second surface 572 may each be formed to have a curved surface to guide rotation of the first step adjustment sheet 510 at the left and the first step adjustment sheet 510 at the right up to a predetermined radius of rotation. Accordingly, the first step adjustment sheet 510 at the left and the first step adjustment sheet 510 at the right may be inserted and withdrawn by rotating horizontally simultaneously along the first surface 571 and the second surface 572 that are in contact with each other. The first step adjustment sheet 510 at the left and the first step adjustment sheet 510 at the right may each include the first withdrawal hole 511.

Likewise, the second step adjustment sheet 520 at the left and the second step adjustment sheet 520 at the right may each include the second withdrawal hole 521, and the third step adjustment sheet 530 at the left and the third step adjustment sheet 530 at the right may each include the third withdrawal hole 531. In this case, the first withdrawal hole 511, the second withdrawal hole 521, and the third withdrawal hole 531 may be formed so as not to overlap each other in the vertical direction. In a stacked state in which the plurality of step adjustment sheets 500 overlap each other, the first withdrawal hole 511, the second withdrawal hole 521, and the third withdrawal hole 531 may all be exposed to the outside in the upward direction. To this end, the second step adjustment sheet 520 and the third step adjustment sheet 530, which are disposed above the first step adjustment sheet 510, may have a cutout portion 560 having an open region overlapping the first withdrawal hole 511 in the vertical direction. In addition, in the third step adjustment sheet 530 disposed above the second step adjustment sheet 520, the cutout portion 560 having the open region overlapping the second withdrawal hole 521 in the vertical direction may be formed. The cutout portion 560 formed in the third step adjustment sheet 530 may be formed to have a greater area than the cutout portion 560 formed in the second step adjustment sheet 520.

Each step adjustment sheet 500 may include the relief portion 550 having an open region overlapping the fastening hole 246 in the vertical direction. That is, in a state in which the step adjustment sheet 500 is fully inserted, the fastening hole 246 and the relief portion 550 may be disposed to vertically overlap each other.

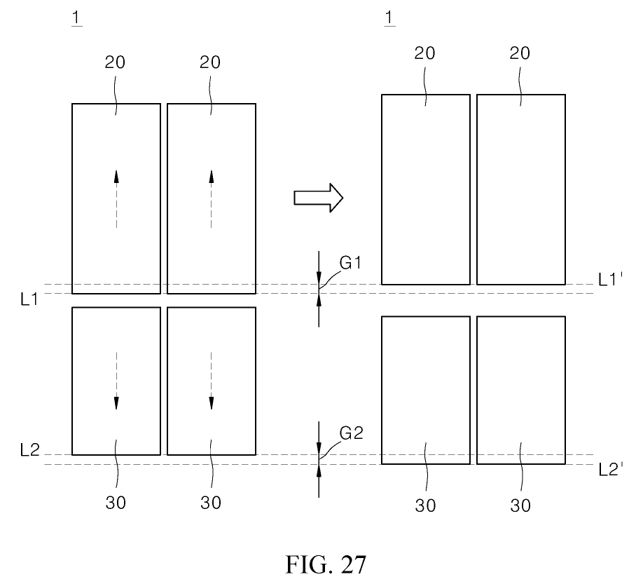

FIG. 27 is a conceptual diagram illustrating one embodiment of step adjustment directions of the first door 20 and the second door 30 in the vertical direction according to the present disclosure. For example, it can be assumed that the step adjustment sheets 500 located on the first door 20 are all in an inserted or added state. The lower end of the first door 20 may be located to correspond to a first minimum height L1, and the lower end of the first door 20 may be raised to correspond to a first maximum height L1’ by withdrawing or removing the step adjustment sheets 500. A difference between the first minimum height L1 and the first maximum height L1’ may correspond to a vertical step adjustment distance G1 of the first door 20. In this case, the vertical step adjustment distance G1 of the first door 20 may correspond to the vertical thickness of the plurality of step adjustment sheets 500 in a stacked state. Accordingly, to increase the vertical step adjustment distance G1 of the first door 20, the step can be easily adjusted by increasing the number of stacked step adjustment sheets 500 or increasing the thickness of the step adjustment sheets 500.

Meanwhile, it can be assumed that the step adjustment sheets 500 located in the second door 30 may all be in a withdrawn or separated state. The lower end of the second door 30 may be located to correspond to a second maximum height L2, and the lower end of the second door 30 may be lowered to correspond to a second minimum height L2’ by withdrawing or adding the step adjustment sheets 500. A difference between the second maximum height L2 and the second minimum height L2’ may correspond to a vertical step adjustment distance G2 of the second door 30. In this case, the vertical step adjustment distance G2 of the second door 30 may correspond to the vertical thickness of the plurality of step adjustment sheets 500 in a stacked state. Accordingly, to increase the vertical step adjustment distance G2 of the second door 30, the step can be easily adjusted by increasing the number of stacked step adjustment sheets 500 or increasing the thickness of the step adjustment sheets 500.

In the refrigerator according to one embodiment of the present disclosure, precise and easy step adjustment in the vertical direction can be achieved even without complete disassembly of the door by stacking step adjustment sheets in multiple layers or selectively allowing each step adjustment sheet to move to adjust the vertical step of the door.

In addition, since the refrigerator according to one embodiment of the present disclosure includes the step adjustment member that is fastened and unfastened in the horizontal direction of the door so that the hinge assembly adjusts the horizontal step of the door, the hinge assembly can precisely adjust not only the vertical step of the door but also the horizontal step of the door.

In addition, in the refrigerator according to one embodiment of the present disclosure, the vertical and horizontal steps of the door may be adjusted through a plurality of step adjustment sheets and step adjustment members in a state in which the hinge member is fixed, thereby preventing a reduction in fastening force between the hinge assembly and the cabinet due to frequent unfastening of the hinge assembly and allowing the step between adjacent doors to be matched more accurately.

Although the present disclosure has been described above with reference to the exemplary drawings, the present disclosure is not limited by the embodiments and drawings disclosed in the present specification, and it is obvious that various modifications can be made by those skilled in the art within the scope of the technical spirit of the present disclosure. In addition, even when the operational effects according to the configuration of the present disclosure have not been explicitly described in the description of the embodiments of the present disclosure, it goes without saying that the effects predictable by the corresponding configuration should be recognized.

What is claimed is:

1. A refrigerator comprising:
a cabinet including one or more storage compartments;
one or more doors configured to open and close the storage compartments;
a hinge assembly connected to a door of the one or more doors and the cabinet so that the door is rotatable from the cabinet; and
a plurality of step adjustment sheets that are stacked or selectively individually moved to adjust a vertical step of the door.

2. The refrigerator of claim 1, wherein the step adjustment sheet is disposed between the hinge assembly and an upper surface of the door or a lower surface of the door.

3. The refrigerator of claim 1, wherein the step adjustment sheet moves in a horizontal direction.

4. The refrigerator of claim 1, wherein the step adjustment sheet is inserted and withdrawn in a sliding manner.

5. The refrigerator of claim 1, further comprising one or more moving guide members configured to connect the step adjustment sheet and the hinge assembly and guide movement of the step adjustment sheet,
wherein the step adjustment sheet includes a slot guide portion that is open in a direction of movement of the step adjustment sheet to allow the moving guide member to pass through the step adjustment sheet.

6. The refrigerator of claim 5, wherein the slot guide portion extends in one direction in a closed loop form.

7. The refrigerator of claim 1, wherein an upper surface of the door or a lower surface of the door includes a recess that is recessed to store a moved step adjustment sheet among the plurality of step adjustment sheet.

8. The refrigerator of claim 1, wherein the step adjustment sheet is separable from the hinge assembly.

9. The refrigerator of claim 1, wherein the step adjustment sheet is rotated about an axis.

10. The refrigerator of claim 1, wherein the hinge assembly includes:
a hinge member including a plurality of joints; and
a hinge mounting plate configured to fasten the hinge member to an upper or lower surface of the door,
wherein the hinge mounting plate includes one or more fastening holes configured to be fastened to the door, and
wherein the fastening holes extend and are open in a horizontal movement direction of the door.

11. The refrigerator of claim 10, wherein the step adjustment sheet is fastened to an upper or lower surface of the hinge mounting plate.

12. The refrigerator of claim 10, wherein the hinge assembly includes a step adjustment member that is fastened and unfastened in a horizontal direction of the door to adjust a horizontal step of the door.

13. The refrigerator of claim 12, further comprising a door mounting bracket whose one side and the other side are fastened to the hinge assembly and the door, respectively,
wherein the door mounting bracket includes a through-hole through that the step adjustment member passes, and
wherein the through-hole includes an extension opening hole extending in one direction along a vertical movement direction of the door.

14. A refrigerator comprising:
a cabinet including one or more storage compartments;
one or more doors configured to open and close the storage compartments; and
a hinge assembly including a hinge member connected to a door of the one or more doors and the cabinet so that the door is rotatable from the cabinet,
wherein the hinge assembly includes, in a state in which the hinge member is fixed, a plurality of step adjustment sheets configured to adjust a vertical step of the door and one or more step adjustment members configured to adjust a horizontal step of the door.

15. The refrigerator of claim 14, wherein the hinge assembly includes a hinge mounting plate configured to guide horizontal movement of the plurality of step adjustment sheets and guide horizontal movement of the door.

16. The refrigerator of claim 15, wherein the door includes a recess that is recessed to store a moved step adjustment sheets among the plurality of step adjustment sheets,
wherein the door is maximally moved upward in a state in which the plurality of step adjustment sheets are stacked between the hinge mounting plate and an upper or lower surface of the door, and
wherein the door is maximally moved downward in a state in which the plurality of step adjustment sheets are seated in the recess.

17. The refrigerator of claim 15, wherein the plurality of step adjustment sheets are inserted and withdrawn in a front-rear direction,
when the step adjustment sheet is withdrawn, the step adjustment sheet that is closer to an upper or lower surface of the door than the hinge mounting plate is withdrawn preferentially, and
when the step adjustment sheet is inserted, the step adjustment sheet that is closer to the hinge mounting plate than the upper or lower surface of the door is inserted preferentially.

18. The refrigerator of claim 15, further comprising a moving guide member that passes through a slot guide portion of the plurality of step adjustment sheets and is fastened to the hinge member,
wherein the slot guide portion is formed to extend in a front-rear direction, and
the plurality of step adjustment sheets are inserted and withdrawn in a sliding manner in the front-rear direction along the slot guide portion.

19. The refrigerator of claim 15, wherein the hinge mounting plate includes one or more fastening holes formed to be fastened to an upper or lower surface of the door by a fastening member, and
the fastening holes extend and are open in a horizontal movement direction of the door.

20. The refrigerator of claim 19, wherein a location of the fastening member located in the fastening holes varies depending on a direction in which the step adjustment member is rotated.
